(19) United States
(12) Patent Application Publication
(10) Pub. No.: US 2005/0085132 A1
(43) Pub. Date: Apr. 21, 2005

(54) Connector pin

(75) Inventors: Chia-Yen Chai, Taipei Hsien (TW); Fu-Chen Chou, Taipei Hsien (TW); Pi-Ching Chen, Taipei Hsien (TW)

Correspondence Address: BRUCE H. TROXELL, SUITE 1404, 5205 LEESBURG PIKE, FALLS CHURCH, VA, 22041, US

(73) Assignee: Comax Technology Inc.

(21) Appl. No.: 10/756,273

(22) Filed: Jan. 14, 2004

(30) Foreign Application Priority Data
Oct. 15, 2003 (TW) 092128610

(51) Int. Cl. H01R 24/00

(52) U.S. Cl. 439/660

(57) ABSTRACT

A connector pin having a definite width of narrow contact surface to connect to a plug pin along the horizontal direction. The contact surface includes a sliding contact area and a contact terminal. A width of the sliding contact area is smaller than a width of the contact surface. When the plug pin reaches the contact terminal, the width of the sliding contact area is smaller than the contact surface. A transmission capacitance of the plug pin and the connector pin is small for better transmission quality.

### BACKGROUND OF THE INVENTION

I. Field of the Invention

This invention relates generally to a connector pin and, more specifically, to a connector pin for high frequency transmission.

II. Description of the Prior Art

Heretofore, it is known that the connection between two cables is through a plug and a corresponding connector for electrical conductive connection, the electrical connection is through the pins of plug and connector, they are connector pin and plug pin.

For the current connector technology, the plug pin must goes through a defined distance to reach to the final position in the connector pin for constant and stable transmission state.

The defined distance described above includes a sliding contact area and a contact terminal, the contact terminal is the final position for the plug pin, the sliding contact area is the overlapped area for the connector pin and the plug pin; electrically, the overlapped area generates capacitance effect and increases conductive impedance to influent transmission bandwidth.

### SUMMARY OF THE INVENTION

It is therefore a primary object of the invention to provide a connector pin for better conductivity and lift the transmission bandwidth.

In order to achieve the objective set forth, a connector pin in accordance with the present invention comprises a definite width of narrow contact surface to connect to a plug pin along the horizontal direction; the contact surface includes a sliding contact area and a contact terminal, the width of the sliding contact area is smaller than the that of the contact surface; when the plug pin reaches the contact terminal, the width of the sliding contact area is smaller than the contact surface, the transmission capacitance of the pins is smaller for better transmission quality.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of a further embodiment of the present invention;

FIG. 2 is an application view of the present invention; and

FIG. 3 is a perspective view of the present invention.

### DESCRIPTION OF THE PREFERRED EMBODIMENT

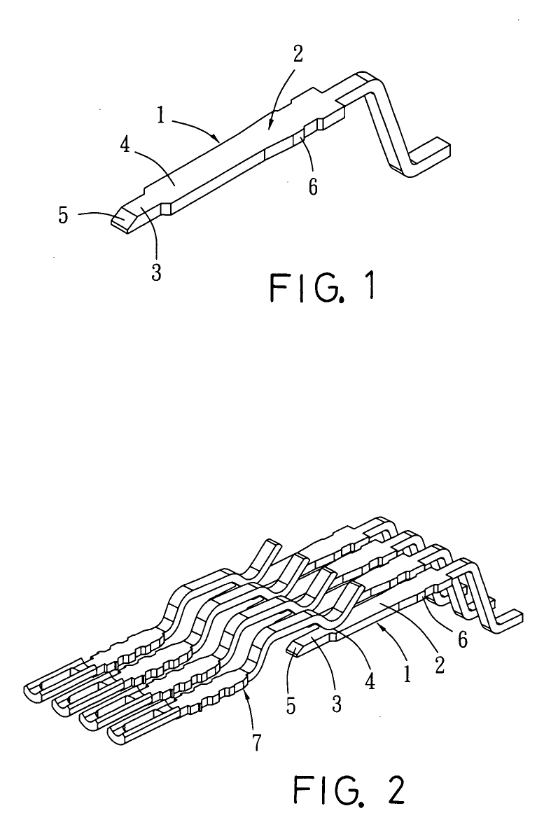

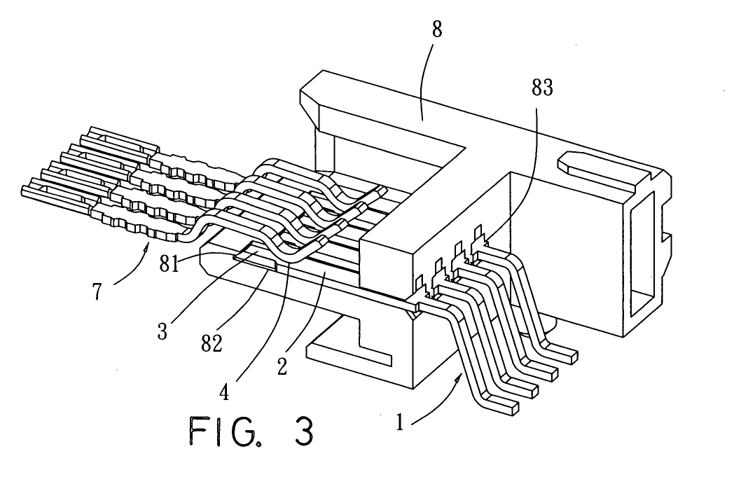

Referring to FIG. 1 and FIG. 2, the present invention is a connector pin 1 with a definite width of narrow contact surface 2 to connect to a plug pin 7 along the horizontal direction; the two ends of the connector pin 1 are plug side and wiring side; along the plug path (the path from the plug side to the wiring side), the contact surface 2 includes a sliding contact area 3 and a contact terminal 4, the contact terminal 4 is the position for the plug pin 7; the width of the sliding contact area 3 is smaller than the that of the contact surface 2, when the plug pin 7 reaches the contact terminal 4, since the width of the sliding contact area 3 is smaller than the contact surface 2, the transmission capacitance of the connector pin 1 and the plug pin 7 is smaller for better transmission quality.

A sliding oblique angle 5 is on the connector pin 1, when the connector pin 1 is packed inside the shell body 8, the sliding oblique angle 5 is buried in to prevent the connector pin 1 from bending; a pair of stoppers 6 are on both sides of the connector pin 1 for the connector pin 1 and the shell body 8 to combine together.

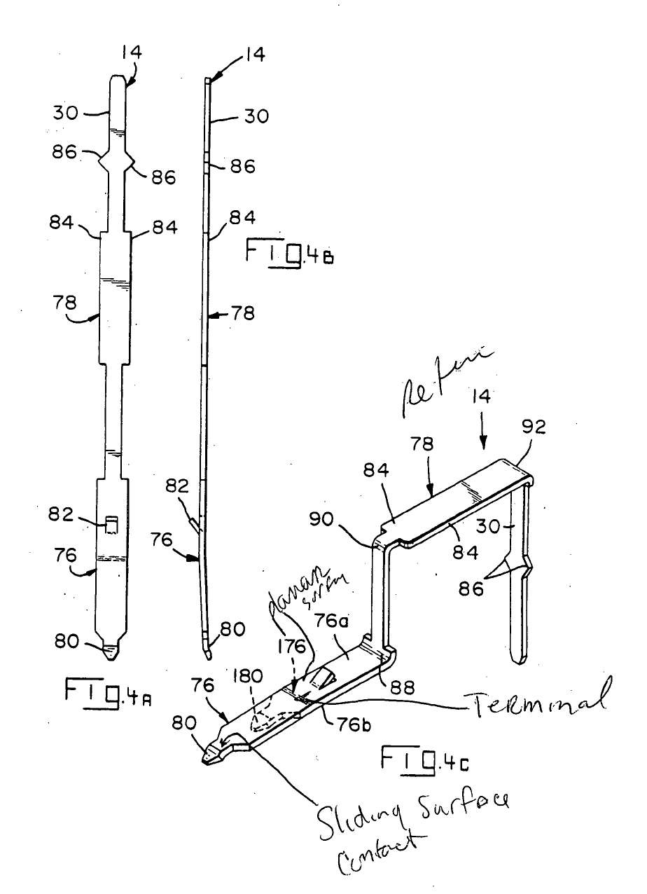

Referring to FIG. 3, a shell body 8 with a plurality of container slots 82 packs the connectors pins 1, the container slot 82 has a oblique concave 81 for the connector pin 1 to insert and prevent the connector pin 1 from bending by the insertion of the plug pin 7 to cause damage; a pair of blockers 83 corresponding to the stoppers 6 are on the two sides of the container slot 82, the blockers 83 are for the connector pin 1 to position and assemble.

During application, the connector pin 1 contacts the plug pin 7, the plug pin 7 slides from the sliding contact area 3 of the contact surface 2 to the contact terminal 4, since the width of the sliding contact area 3 is smaller than the contact surface 2, the transmission capacitance of the connector pin 1 and the plug pin 7 is smaller for better transmission quality, the bandwidth of the transmission is wider.

While a preferred embodiment of the invention has been shown and described in detail, it will be readily understood and appreciated that numerous omissions, changes and additions may be made without departing from the spirit and scope of the invention.

1-3. (canceled)

4. A connector pin for use with a plug pin and located in a shell body, the connector pin comprising:
a) a planar contact surface having a sliding contact area and a contact terminal selectively connected to the plug pin, the sliding contact area is located adjacent to the contact terminal and has a width that is narrower than a width of the contact terminal; and
b) two stoppers, one of the two stoppers extending outwardly from each of two opposing sides of the planar contact terminal,
wherein the connector pin is located in a container slot in the shell body.

5. The connector pin according to claim 4, wherein the sliding contact area includes a sliding oblique angle located on an end thereof opposite the contact terminal and inserted into an oblique concave hole located in the container slot of the shell body.

6. The connector pin according to claim 4, wherein each of the two stoppers engage a blocker located in the container slot of the shell body.
